(19) United States
(12) Patent Application Publication
(10) Pub. No.: US 2011/0173024 A1
(43) Pub. Date: Jul. 14, 2011

(54) INDIVIDUALIZATION OF MEDICAL ADJUVANTS

(75) Inventors: Ahmet Konya, Ludwigshafen (DE); Hans-Juergen Kuhr, Mannheim (DE)

(73) Assignee: Roche Diagnostics Operations., Inc., Indianapolis, IN (US)

(21) Appl. No.: 13/063,113

(22) PCT Filed: Sep. 8, 2009
(86) PCT No.: PCT/EP09/06507

§ 371 Date: Mar. 9, 2011

(30) Foreign Application Priority Data
Sep. 9, 2008 (EP) 08015878.5

(51) Int. Cl. G06Q 50/00

(52) U.S. Cl. 705/2

(57) ABSTRACT

A method for upgrading a medical device for the treatment of diabetes in the home-monitoring field includes the steps of providing consumables in a housing with a type-specific identification code for use in a medical device, storing the identification code in combination with a user identification and determining a user status, offering a selection according to the user status of at least one configuration of a supplemental module for the medical device, and generating a delivery order for a supplemental module based on the selection made by the user.

### RELATED APPLICATIONS

The present application is based on and claims priority to PCT/EP2009/006507, filed Sep. 8, 2009, which claims priority to EP 08015878.5, filed Sep. 9, 2008, the entire disclosures of which are expressly incorporated herein by reference.

### FIELD OF THE DISCLOSURE

The present disclosure relates to a method for upgrading medical devices.

### BACKGROUND AND SUMMARY THE DISCLOSURE

For the user of medical devices such as analyzers, pump systems or other diagnostic and therapeutic devices in the home-monitoring field and especially for diabetes patients which have to carry out actions in connection with their disease several times daily, it is becoming more and more important to be able to handle these medical devices in an easy and comfortable manner. Another growing trend no only in the home-monitoring field is the ability to individually adapt such devices as much as possible for personal use and taste.

In the prior art one way of accomplishing this is described in EP 1 279 365 which is to provide a glucose meter with an additional surrounding housing which does not impair the function of the glucose meter but provides the patient with a better grip or colouring as well as additional information for the system and thus the patient. A disadvantage of this additional surrounding housing is that the user cannot influence the design of this surrounding housing. Accordingly, it is desirable to provide the users of medical devices a means for individualizing the disease-related devices and utensils.

In one embodiment of the present disclosure, a method is provided for upgrading a medical device for the treatment of diabetes in the home-monitoring field comprising the following steps:
providing consumables in a housing with a type-specific identification code for use in a medical device,

storing the identification code in combination with a user identification and determining a user status,

offering a selection according to the user status of at least one configuration of a supplemental module for the medical device, and generating a delivery order for a supplemental module based on the selection made by the user.

Even if this method is described for the clinical picture of diabetes, it can also be applied to other home-monitoring patients who, for example, have to frequently determine their coagulation value or have to check their urine value which is why the application is not restricted to diabetes.

This method enables the user to independently and individually put together additional supplemental modules for medical devices by collecting a credit in the form of an identification code. In this case it is completely irrespective of which consumables he has bought to get this credit which he can for example obtain by adding different identification codes. The method offers the user the ability to combine the credit in the form of the identification code together with additional information in the form of a user identification and thus to get an offer of a user-specific selection of at least one configuration of a supplemental module for the medical device. The system can completely individually compile a wide variety of supplemental module combinations for the users on the basis of different user-specific requirements such as on the basis of age or also on the basis of the disease status or other user-specific data. Since the various user groups have different requirements for the medical devices, these different requirements can thus be taken into account.

As a result children can, for example, be offered the supplemental modules in a colour or design that is different from that offered to the older user for whom good handling qualities and good readability of for example measurement results are especially important. In addition to age, disease-specific data may also result in a different type of selection. Thus, a diabetes type I patient would be presented with a different selection to that of a diabetes type 2 patient. Other diseases can also lead to additional supplemental modules being offered from this disease setting.

Hence, the method allows an individual configuration which means that the child user group can for example be encouraged by means of a colour design to carry out a sufficient number of measurements because the instrument with the supplemental module can be designed more like a toy. In contrast, managing of a disease can be made easier for an older user by a supplemental module which for example has an additional large display for showing the measured glucose values. In this manner the patient can improve the management of his disease by the individualization.

This individualization is not possible due to the manifold portfolio of already existing medical devices such as measuring instruments, lancing aids and insulin pumps without an additional individualization process because the variety of configurations of design as well as functional features would not make it feasible for them to be directly offered to the user when he buys a device. The additional possibility of individually adapting the medical device to one's own needs by means of a supplemental module makes it for the first time possible to offer the necessary and design variations to a large number of user groups in a cost-effective and practical manner.

In a second embodiment, an individualization method of a hand-held management system is described comprising the steps:
providing a selection of design or functional properties of a surrounding housing for an independently functional medical device where the surrounding housing at least partially surrounds the medical device,

registering the selection made by the customer of at least one property of the surrounding housing, characterized in that the design or functional properties of the surrounding housing can be individually put together when selecting the surrounding housing and a corresponding order for the delivery of the selected surrounding housing is generated.

The claimed method is also a means for the user to individualize where in this embodiment the user can individually design a supplemental module in the form of a surrounding housing for an already independently functional medical device. This offers the user the possibility of firstly buying a medical device such as for example a lancing aid or an analyzer which can function independently (i.e. all functions which are necessary to for example carry out a blood glucose measurement or to administer insulin are present). However, the individualization method enables the user to subsequently configure this medical device so that it meets his individual demands. Such an independently functional module that can be supplemented by an additional surrounding housing in order to incorporate further functions into the system has already been described in EP 1 967 139 in the form of a lancing aid stored in a magazine.

Both of the methods described here are based on the principle of individualizing supplemental modules such as surrounding housings or additional components for the medical device but also the ability to individually select and/or configure additional software. This can take place on the basis of a reward process in which the user can obtain a credit by buying consumables and the credit can be collected by means of an identification code on the consumable and redeemed in due course in the form of a supplemental module for a medical device. The user can vary his credit in both cases by additional payment.

In this connection it is desirable to allow a plurality of consumable units of variable design (e.g. in the form of a magazine of different consumables such as lancing elements, test elements or insulin amounts) to functionally interact with the medical device independently of their amount of consumable. This can be achieved by a system which can interact with a magazine and a magazine which contains the consumable and can be inserted into the medical device. The system is characterized in that the magazine can be provided with a different number of consumables in the unused state. In this connection the medical device can be configured such that it automatically detects the number of consumables (e.g. on the basis of the identification code or of another code). This information can be displayed to the user as well as stored and processed in a data storage or data processing unit.

In EP 1 967 139, this storage of lancets is provided in the form of a tape in a magazine in which the embodiment of storage in the form of a tape which is movably mounted between two rollers allows the number of lancets to be varied by for example varying the distances between the lancets or varying the overall tape length in the magazine without the magazine having to have a different shape or size. The housing can have the same size for a store of between 1 and about 400 lancets.

This principle of storage in the form of a tape can not only be used for lancing elements but also for example test elements, integrated lancets with test elements or other consumables that can be stored in a magazine. As a result, the design of a surrounding housing does not have to be adapted with respect to size to the independently functional lancing aid with an integrated magazine in the case of different amounts of lancing elements. This additionally enables surrounding housings of very different designs to be made available in a cost-effective manner. Consequently, the design of the described system enables the realization of individualization methods as described previously.

This allows a user who has a high consumption of consumables due to his disease to be rewarded in a special manner. Since the system can always interact with the same medical device irrespective of the amount of consumables, different degrees of magazine fillings can be provided without the user needing a different medical device. This can be achieved on the basis of a uniform size of the magazine irrespective of the number or amount of the consumable. Alternatively, an adapter module can be provided which is either attached to the magazine or to the medical device in order to be able to attach magazines of different sizes to the same receiving point of the device. This does not impair the functionality of the magazine and medical device. In this connection the amount of credit that is stored in the identification code can either increase linearly with the amount of consumable or increase disproportionally (e.g. more rapidly) with an increasing amount of consumable provided per magazine.

The upgrading or individualization method according to the invention can be carried out with the aid of a computer program which is either provided on a data carrier such as a CD ROM, USB stick or diskette, or is made available to the user by a network (e.g. via internet).

In this process the user is for example provided with an input mask in which he can enter the required data such as identification code and/or user identification in order to have a selection of products displayed with the aid of these data which corresponds to his user status that was determined from the information of the identification code and/or the user identification.

In this connection there are numerous ways in which the program can present the selection to the user. One alternative is that different selection displays are generated to the user on the basis of an identification code and his user identification. Another alternative is that the user can generate a fictitious selection of user statuses which are of interest to him. As a result, the user is given the opportunity of looking at product combinations which are of interest but which he cannot yet afford with his current credit. This may motivate him to increase his credit and thus achieve a better status of his disease monitoring and therapy. The program additionally enables personal data and credit amounts to be stored which are not transacted until a later date in the form of a delivery.

Alternatively all stored products (in the form of supplemental modules) can be displayed to the user so that he can decide whether he wishes to add further identification codes in order to obtain a larger selection. In this connection the user identification can be optionally used to select the displayed products or it can be disregarded. In a subsequent step the user is offered the possibility to make an order out of his selection resulting in the delivery of the selected supplemental module.

According to this method, the user can at any time individually add to and/or configure his current utensils which he requires to manage his disease according to his taste and his requirements such as for example analyzers (AccuChek® Active®, Aviva®, Compact®), lancing aids (Accu-Check® Multiclix@), insulin pumps (Accu-Chek® Spirit®), or data processing devices (Accu-Chek® Smart Pix®).

Even if the user currently has no credit on hand in the form of an identification code, he can get a picture of the options for configuring his devices/utensils and their design in the form of a supplemental module. For this purpose the input module enables a fictitious identification code to be entered or products for different user statuses to be displayed without having to actually purchase an identification code.

### Medical Devices

Medical devices can be regarded as all analyzers, lancing aids, data processing systems, insulin pump systems, continuous measuring devices as well as any utensils which a user in the home-monitoring field needs to treat his disease. These medical devices are preferably loaded with consumables and the consumable can be provided with an identification code or, when the consumable is bought, can directly lead to a selection of a supplemental module by the patient (e.g. in the form of a surrounding housing for the medical device). The medical device can preferably function without the supplemental module and can be upgraded or individualized by a supplemental module. The supplemental module can in this connection also be a medical device. This can also be independently functional.

In one embodiment, the medical device is suitable for the analysis or treatment of a diabetic and can comprise a receiving site for one or more consumables as well as at least one consumable which can be inserted into the receiving site where the consumable has an identification code. In addition the device can comprise a read-out unit which is designed to read out the identification code on the consumable for further processing in a data storage and data processing unit which is designed to add different identification codes or combine an identification code with a user code. This enables user-specific data to be determined which for example can lead to the selection of certain modules or supplemental modules having certain configurations in a data base.

Furthermore, the medical device can comprise a device to indicate a sufficient score to upgrade the system. This device can have an acoustic, graphic or haptic embodiment. For this purpose the identification code or a combination of several identification codes and/or one identification code can be combined with the user code in order to determine whether a sufficient score has been reached which is either specified by the user or the system. Thus, for example when the user wants to have a certain supplemental module, a threshold can be set and when it is exceeded the device indicates that this score has been reached. Alternatively or in addition the score can be compared with scores in a data base for supplemental modules and the user is shown on the medical device which selection of supplemental modules could be selected with this score.

A unit can be provided in the medical device which automatically enables the device to transmit this score to a central database as soon as the device is linked to this database for data exchange. This medical device can be connected to the database via cable connections or be wireless connected by an infrared, radio or bluetooth interface. In this connection the device can automatically make the connection with the database which can either be triggered by reaching a certain measured value or a certain number of measured values or by reaching a certain score.

The device can have acoustic, graphic or haptic means in order to inform the user about various statuses. This can for example be the measurement result of a measurement or a threshold value which has been exceeded either by a measurement signal or a score. Other statuses such as the battery status or other instrument functions can be indicated to the user by this indicating means.

In addition the medical device can also be equipped with a sensor system which on inserting the consumable immediately recognizes whether it is a newly inserted consumable or a consumable that has already been at least partially used. In this connection the amount of the consumed or not yet consumed consumable can be indicated. This prevents a consumable that has already been used once from being utilized again to upgrade the score. In addition the medical device can have a device which enables the identification code to be changed such that when the consumable is inserted again or when the same consumable is inserted into another medical device, it is immediately recognized that this consumable has already been identified once and registered. This can for example be carried out by means of laser irradiation where the laser can also be used to read out a code. It can, however, also be a mechanical mark which changes or destroys at least parts of the identification code.

### Consumable

Depending on the medical device that is used, the consumables can be present in the form of, for example, lancing elements, such as lancets, analytical test elements, catheters, insulin cartridges or other utensils which a diabetic requires to treat his diabetes in conjunction with a medical device. In this connection the design of these consumables is not limited and they can be of any shape or functionality a wide variety of which are known in the prior art. A multiple use is for example also possible. However, they are preferably disposable units.

The consumables are typically accommodated in a housing such as for example a magazine or storage container. They can also be plastic or glass cartridges for storing liquids. In this connection the consumables can either be removed individually and interact with the device or if a magazine is used, they can also directly interact with the device in a magazine form so that the consumable can be directly made available when the medical device is used. Furthermore, any supplementary means for the medical device can be also regarded as a consumable such as for example an additional surrounding housing or other supplemental modules for the medical device. The surrounding housing preferably interacts with the medical device such that it at least partially surrounds the device. As a result, the appearance as well as the range of functions of the medical device can be changed.

Since even medical devices such as lancing aids, analyzers and insulin pumps do not have an infinite lifespan, they can also be regarded as consumables in the sense of the disclosure and consequently be provided with an identification code. In this special case the medical device is at the same time the consumable.

The consumable or the magazine containing consumables can be configured such that it always has the same size irrespective of the number of consumables in order to be inserted into the receiving site of the medical device.

### Supplemental Module

A supplemental module is understood in the sense of the invention as any additional element which may be beneficial to the user in the management of his disease. They can be components which can be used independently of the medical device or which can directly make a mechanical or electronic connection with the medical device. For example, in addition to the normal functionality of the medical device, they can be attached to the medical device or be activated or implemented therein, or interact in any form with the medical device. Interact can be understood as all mechanical or electronic interactions between the medical device and the supplemental module.

The supplemental module can either be a hardware module (e.g., surrounding housing with or without additional functions, a bag, grip surfaces), or a software module. The software module can for example be already implemented on the medical device but not yet activated when the device is bought and be unlocked directly on the medical device by provision of the identification code. Alternatively the supplemental module can be activated by electronically transmitting the identification code to a centre or database which in combination with the user identification electronically unlocks the feature. This activation can take place by transmitting an additional code to the user who enters this code into the medical device, it can, however, also take place directly and electronically on the device when it is configured for this purpose.

Another alternative for transferring codes and instructions is transmission via mobile telephones or similar electronic devices which have a transmission function. In this manner the medical device only has to have an interface for the transmitter in order to transfer the code or instructions. This can for example take place by means of a normal hardware interface such as for example USB or by means of a bluetooth or infrared interface.

In another embodiment, the supplemental module is a surrounding housing which can contain design components as well as functional components. It can, however, also be an additional supplemental module such as for example a torch, a laser pointer or a USB stick which can interact in a modular or functional manner with the medical device. Further supplemental modules which do not interact directly with the medical device are a storage space addition (e.g., for test elements) or an upgrade in the form of a display device or a display.

However, the surrounding housing is preferably provided with additional supplemental modules which represent an additional functional component for the medical device. This group for example comprises:

1. An additional surrounding housing to enlarge the system in order to improve the handling for example by older persons.

2. Connection of an electric drive for automatically tensioning for example a lancing device.

3. Extension comprising a counter for used and/or fresh lancets or test elements.

4. Extension comprising a sensor for checking the finger pressure.

5. Extension comprising a blood glucose measuring instrument.

6. Electronic trigger mechanism for a lancing device.

7. Electronic display for the amount of unused consumable and many more.

### Identification Code

The identification code which can be located on, at or in the various types of consumables can be any form of pictorial or electronic imaging of information. In this connection the identification code can also comprise information about the type of the consumable as well as its amount. Examples of this are optical or electronic bar codes, reference numbers, glued on scores or other means that can be read out by the user or electronic devices in an optical or electronic form. In the case of an electronic read-out this can be provided by means of an additional device or by means of the device into which the consumable is inserted.

The further processing (e.g., in the form of storage of the identification code) can also either take place purely mechanically by the user in that he transfers the glued on images for example in the form of points onto a form which he subsequently uses to make an order. However, direct transfer to a computer or a network by connecting the medical device which has stored the identification code can alternatively also take place by transmitting the data to the end processing device for example by bluetooth or other electronic transfer methods. The identification code is at least temporarily stored and further processed on the end processing device which is either the medical device itself or a computer, but can also be a database or an input program. As already mentioned, this further processing can also comprise the steps of combining a user identification (if present) and/or the provision of a selection of products.

The identification code contains credit information which enables the user to order supplemental modules for medical devices with the aid of this code. The information from various identification codes can be combined with one another and can thus lead to a different or extended selection of supplemental modules for the user.

### User Identification/User Status

The identification code can be used together with a user identification to provide a selection of at least one embodiment of a supplemental module for the medical device. In this connection the user information can be either merely a user identification (e.g., in the form of a name) or an identification number or other information.

In the case of an activation of a feature that is already present on the medical device, this user identification can be information (for example, identifier or type name of a device) about the medical device.

Furthermore, personal data can be added as the user identification which can for example be the age of the user, certain preferences of the user, information about devices or utensils that have been previously used by the user or other data pertaining to his person.

This user identification can comprise additional information about the disease status of the user so that this information can be used together with the identification code to provide a differentiated selection for the user in the selection program. This information about the disease status can for example in the field of diabetes be information about whether the user is a type 1 or type 2 diabetes patient, whether he is insulin-dependent or not insulin-dependent, which systems he has previously used and which additional diseases he has.

If the selection program is for example present in the form of a catalogue, such disease-related information can only be displayed in a limited manner, however even in this case it is possible to differentiate between potentially appropriate supplemental modules for different disease groups such as for example type 1 diabetes and type 2 diabetes because the type 1 diabetic is usually insulin-dependent whereas the type 2 diabetes patient does not yet have to be insulin-dependent. Thus, the type 2 diabetes patients would not be offered a selection of all utensils in the form of supplemental modules from the insulin pump range, unless he specifically requests it.

### Design or Functional Components

In order to enable the user to individualize existing utensils/devices, the user can select design components as well as functional components when selecting a supplemental module. Design components include in particular:

1. Color

2. Pattern

3. Optical effects

4. Size of the supplemental module for optical upgrading

5. Haptics (e.g., surface texture)

6. Ergonomics (shape).

These design components are used in particular to individualize the supplemental module and thus also the devices. This should allow the user to relate better to his utensils associated with his disease. It should increase the awareness of the user with regard to correct behavior in dealing with his disease. This includes a regular determination of the glucose level in the blood for diabetics or a better control of insulin therapy.

The functional components can be:

1. Additional devices such as lancing devices, analyzers, insulin pumps that can be functionally coupled to the existing system or device.

2. Additional consumables such as lancing elements, test elements etc.

3. Variation of the size of the supplemental module to customize the handling of the medical device (e.g., for the visually impaired or elderly people).

4. Additional surrounding housing in order to incorporate further functions into the medical device such as
additional trigger button for a measuring device or lancing device,
automatic display of unused consumables, or
display to show diverse results and other data and much more.

These components can be used individually or in combination.

### BRIEF DESCRIPTION OF THE DRAWINGS

FIG. 1 is a schematic diagram of an upgrading process of a medical device with the aid of an identification code.

FIG. 2 is a schematic representation of an individualization process for a surrounding housing.

FIG. 3 is a diagram of a medical home monitoring system with different numbers of consumables.

### DETAILED DESCRIPTION OF EMBODIMENTS OF THE DISCLOSURE

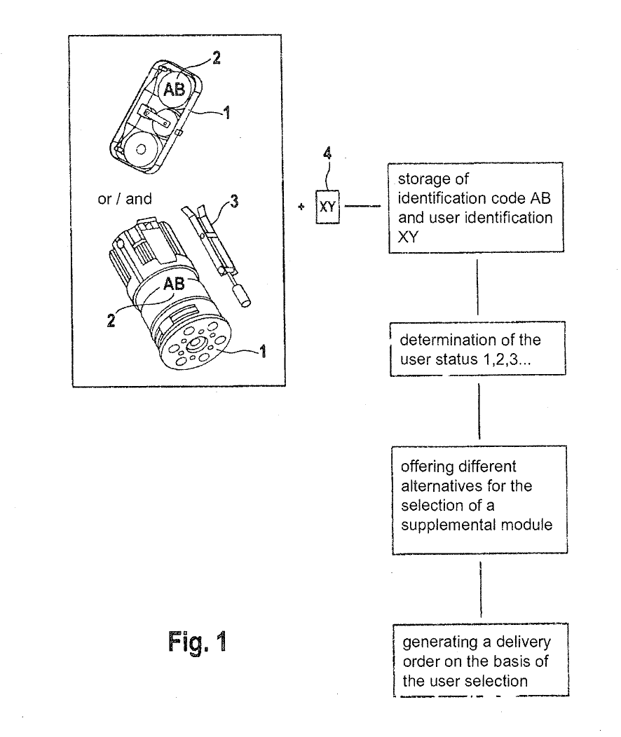

The sequence of process steps for upgrading a medical device is shown in FIG. 1. In this process a consumable (1) which in this example is shown as a magazine for test elements or for lancets (3) is provided. An identification code (2) which together with the user identification (4) is stored on a data processing device (e.g., a computer, a database on an internet server) or is noted by the user on a form, is affixed to this consumable (1). A user status is electronically or manually determined on this data processing device or form with the aid of the identification code (2) and the user identification (4) from a series of stored or printed user statuses (1, 2, 3 . . . X). The user is offered various alternatives for selecting a supplemental module on the basis of this user status. This can be in the form of a list of product names together with the credit required to obtain this supplemental module, or alternatively the various supplemental modules can be represented graphically which is particularly appropriate in the case of the design configurations of the supplemental modules. In this process the user can select a combination of different components of the supplemental module (e.g., combine the color with a certain pattern or other functions for a supplemental module).

In the case of an electronic processing of the data, the necessary credit amount for his combination can be shown to the user at any time and compared with the entered identification code or user status.

Once the user has made a selection, he can generate a delivery order in the next step on the basis of his selection. When using an electronic selection module, this can be in the form of an electronic order or in the case of a catalogue as the selection module it can be in the form of a delivery order by means of a form on which the necessary data such as identification code and user identification have been entered.

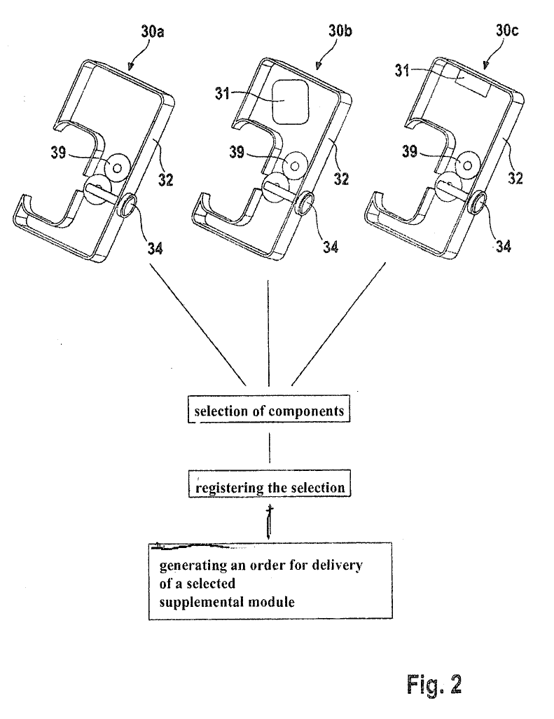

Three different embodiments of a surrounding housing (30a, 30b, 30c) are shown in FIG. 2 which differ from one another with regard to their functionality or design. Starting with the surrounding housing (30a) without an add-on element (31), the surrounding housing can have a variety of add-on elements (31) which is for example shown for the surrounding housing (30b) in the form of a display (31) or alternatively the surrounding housing (30c) has an add-on element (31) in the form 20 of a USB interface. This is intended to show an example of how a selection of design or functional properties of a surrounding housing can be provided for an independently functional medical device as would be the case for a lancing device (which is not shown here). This surrounding housing (30a, 30b, 30c) can for example additionally comprise a housing wall (32), a trigger (34), an interface (36) 25 as well as a drive (39).

After the user has selected components this selection is registered by recording the user selection in a form or by the selection program on a computer or in a database. An order for supplying the selected supplemental module can be generated on the basis of this registration if the user wishes to do so. In one embodiment, a user identification (e.g., in the form of an address or a user identifier) is also required in this case as described for the system of FIG. 1 in order to allow the user to be sent his selected supplemental module.

The options for a surrounding housing shown as an example in FIG. 2 can be carried out electronically or also in writing as already described for FIG. 1. The options for showing different design components as well as functional components can be shown to the user in a considerably simpler and more convenient manner with an electronic data processing program or a database.

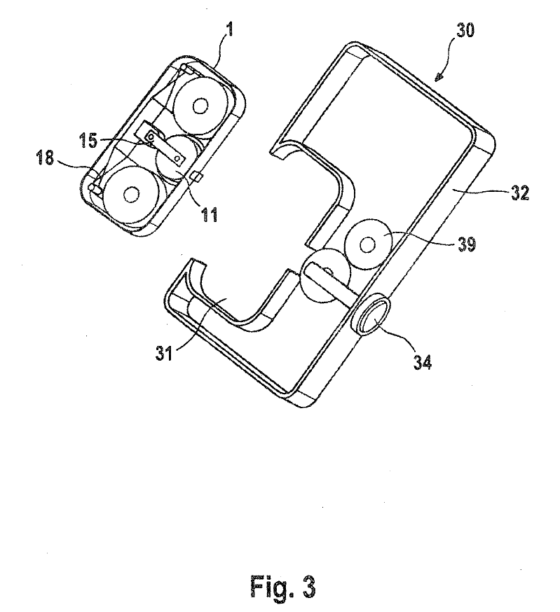

FIG. 3 shows a consumable (1) in the form of a magazine for lancets or test elements. The lancets or test elements are fastened on a tape (18) which is moved by a drive mechanism (15) to the lancing position and has a drive mechanism (11) for stepwise advancement in order to advance the tape to the next consumable. A special propulsion mechanism allows the magazine to have the same form and size independently of the number of consumables (1) such as test elements or lancets. This has the advantage that the surrounding housing (3) as shown in FIG. 3 does not have to be additionally adapted to the size of the lancing device or test element magazine but rather at least the receiving position in the form of a recess (31) can have a universal size. This results in an economization of production costs which can benefit the user in that he can select additional features for a supplemental module (30) without having to incur high costs.

1. Medical device for the analysis or treatment of a diabetic comprising:
a receiving site for one or more consumables,
at least one consumable which can be inserted into the receiving site where the consumable has an identification code,
a read-out unit which is designed to read out the identification code on the consumable,
characterized in that it additionally comprises a data storage and data processing unit which is designed to add different identification codes and/or combine an identification code with a user code.

2. Medical device according to the previous claim, characterized in that the device comprises a device to signal a sufficient score to upgrade the system.

3. Method for upgrading a medical device for the treatment of diabetes in the home-monitoring field comprising the steps:
providing consumables in a housing with a type-specific identification code for use in a medical device,
storing the identification code in combination with a user identification and determining a user status,
offering a selection according to the user status of at least one configuration of a supplemental module for the medical device
generating a delivery order for a supplemental module based on the selection made by the user.

4. Method according to claim 3, characterized in that the identification code contains information about the amount of the consumables.

5. Method according to one of the previous claims, characterized in that the medical device is a lancing device, an analyzer or an insulin-injection module.

6. Method according to one of the previous claims, characterized in that the supplemental module configuration contains design components and/or functional components.

7. Method according to one of the previous claims, characterized in that the supplemental module is a surrounding housing and at least partially surrounds the medical device in a removable manner.

8. Method according to one of the previous claims, characterized in that the user identification contains information about the disease status of the user.

9. Method according to one of the previous claims, characterized in that the selection of the supplemental module is offered depending on the user status.

10. Method according to claim 6, characterized in that the functional components belong to the group
additional trigger button
automatic display of unused lancets
additional consumables such as lancing elements, test elements etc.
variation of the size of the supplemental module for the customized handling of the medical device
automatic display of unused consumables
display to indicate various results and other data.

11. Method for individualizing a hand-held diabetes management system comprising the steps:
providing a selection of design or functional properties of a surrounding housing for an independently functional medical device where the surrounding housing at least partially surrounds the medical device,
registering the selection made by the customer of at least one property of the surrounding housing,
characterized in that the design or functional properties of the surrounding housing can be individually put together in the selection of the surrounding housing and a corresponding order for the delivery of the selected surrounding housing is generated.

12. Method according to claim 11, characterized in that the surrounding housing functionally interacts with the device when it is used with the medical device.

13. Medical home-monitoring system for the analysis or treatment of a diabetic comprising:
a medical device which can interact with a magazine,
a magazine containing consumables and which can be inserted into the medical device,
characterized in that the magazine can be provided with a different amount of consumables in the unused state.

14. System for use in a method according to claim 3 or 11, characterized in that the supplemental module can be individually selected from different combinations of features depending on the amount of consumables in the medical device.

15. System according to claim 13, characterized in that the magazine has the same housing size for different numbers of consumables.

16. Computer or network with a programme for selecting configurations of supplemental modules for medical devices for carrying out the method according to claim 3 or 11.

17. Data base for providing data for selecting configurations of supplemental modules for medical devices according to claim 3 or 11.
